(19) United States
(12) Patent Application Publication
(10) Pub. No.: US 2012/0183409 A1
(43) Pub. Date: Jul. 19, 2012

(54) Turbine blade, turbine shaft, turbine system and method for installing the turbine blade

(76) Inventors: Christoph Ebert, Dresden (DE); Detlef Haje, Gorlitz (DE); Albert Langkamp, Dresden (DE)

(21) Appl. No.: 13/498,921

(22) PCT Filed: Sep. 3, 2010
(86) PCT No.: PCT/EP2010/062940

§ 371 Date: Mar. 29, 2012

(30) Foreign Application Priority Data
Sep. 30, 2009 (DE) 10 2009 047 799.3

(51) Int. Cl. F01D 5/14; H05B 6/64

(52) U.S. Cl. 416/230; 219/678

(57) ABSTRACT

A turbine blade of fiber-reinforced plastic material is provided. The turbine blade includes a blade root as a connecting element that is connectable to a turbine shaft. The turbine shaft has a groove for accommodating the blade root in the installed state of the turbine blade on the turbine shaft. The blade root has a shape of fit finely matched to the shape of the groove of the turbine shaft as a result of a heating effect produced by a heating arrangement and acting on the blade root during installation on the turbine shaft and as a result of auto-adaptation of the shape thereof to the shape of the groove of the turbine shaft.

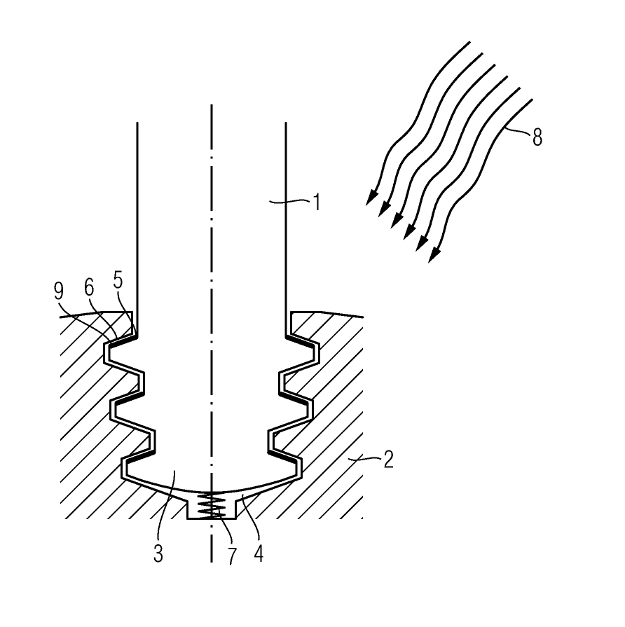

### CROSS REFERENCE TO RELATED APPLICATIONS

This application is the US National Stage of International Application No. PCT/EP2010/062940, filed Sep. 3, 2010 and claims the benefit thereof. The International Application claims the benefits of German application No. 10 2009 047 799.3 DE filed Sep. 30, 2009. All of the applications are incorporated by reference herein in their entirety.

### FIELD OF INVENTION

The invention relates to a turbine blade made of fiber reinforced plastic material, a shaft having such a turbine blade and a turbine system having the aforementioned shaft. The present invention also relates to a method for installing a blade of the aforementioned type on a turbine system shaft.

### BACKGROUND OF INVENTION

To increase the output and efficiency of future turbines or rather turbine systems, hereinafter also referred to as turbines for short, the aim is to enlarge the flow cross-sectional area particularly of a last turbine stage in the case of a multistage turbine, i.e. increase the speed of the turbine. Conventional materials for the turbine blades of the turbine shafts installed in the turbine, such as steel or titanium, are nowadays already coming up against their physical limits.

An improvement is achieved here if fiber composite materials of high strength per unit weight are used for the turbine blades of at least a last turbine stage of a multistage turbine, i.e. a rearmost and therefore coolest turbine stage. Such a turbine blade has a blade root with which the blade is attached to an e.g. steel shaft of a turbine in question. The turbine shaft in turn has a groove in which the turbine blade root is mounted when the turbine blade is installed on the relevant turbine shaft.

However, the bearing strength of blade roots made of fiber composite materials is often reduced by stress concentrations due to point and linear loads at locations on the blade root where it is supported on corresponding wall sections of the groove of the turbine shaft in the installed state. These local loadings of the blade root result from shape and position differences between the root of the turbine blade and the relevant wall sections in the turbine shaft groove in which the blade root is fixed.

The places on the blade root which are supported on corresponding wall sections of the groove of the turbine shaft can be implemented as bearing surfaces by means of which an increased retaining force of the blade root in the groove of the turbine shaft is achieved. The bearing surfaces can in turn be part of e.g. a fir tree shape possessed by the blade root and with which the blade root is screwed into an associated groove of the turbine shaft which has a shape complementary to the fir tree shape of the blade root.

In steam or stationary gas turbine systems, hereinafter referred to merely as steam or gas turbines, exclusively metal turbine blades are currently used. Here differences in the shape and position of the root of a turbine blade and the relevant associated groove of a turbine shaft likewise occur. In order to minimize the stress concentrations resulting from the point and linear loads, immense time and effort is spent on machining the root and groove of the turbine blade and shaft.

### SUMMARY OF INVENTION

To install the turbine blade on an associated turbine shaft, a root of the turbine blade is inserted in a shaft groove having a shape complementary to that of the blade root.

The object of the present invention is, on the basis of a turbine blade, turbine shaft and turbine system of the respective type referred to in the introduction, to improve the turbine blade, turbine shaft and turbine system in technical terms such that the bearing strength of a fiber composite blade root of a turbine blade, which is installed by inserting said blade root in a groove of a turbine shaft, is increased by reducing stress concentrations at blade root locations where the blade root is supported on corresponding wall sections of the groove of the turbine shaft, thereby extending the service life of the turbine blade, turbine shaft and turbine system.

The object of the present invention is also, on the basis of a method of the type referred to in the introduction, to improve said method in technical terms such that the service life of the turbine blade and therefore a turbine shaft having such a turbine blade and a turbine system having a turbine shaft having such a turbine blade is increased.

The above objects are achieved by the features of the independent claims.

The measures according to the invention achieve the result that the bearing strength of a fiber composite blade root of a turbine blade is increased by reducing stress concentrations at critical locations in a groove of the turbine shaft, in which groove the blade root is supported in an installed state, thereby simultaneously extending the service life of the turbine blade, turbine shaft and turbine system according to the invention.

With the inventive measures, the surfaces of a blade root are matched as precisely as possible to the surfaces of a respective mounting groove on a respective turbine shaft, thereby significantly reducing stress concentrations due to point and linear loads. This considerably increases the bearing strength of the fiber composite blade root and therefore extends the service life of the respective turbine blades, turbine shafts and turbine systems. By heating of the fiber composite blade root, the limited moldability of the generally duromer matrix in the fiber composite material is utilized for shaping to match existing geometries.

The turbine shaft according to the invention has at least one turbine blade according to the invention, which means that the advantages of the turbine blade according to the invention extend to the turbine shaft.

The turbine system according to the invention has at least one turbine shaft according to the invention, which means that the advantages of the turbine shaft according to the invention extend to the turbine system.

According to the inventive method, during installation, i.e. immediately before, during or after insertion of the blade root in the groove of the turbine shaft, the blade root of a turbine blade made of a fiber composite material is particularly finely matched, on the turbine shaft, to the shape of the groove of the turbine shaft by a thermal effect produced by a heating arrangement and, as a result of said thermal effect, by auto-adaptation in the shape of fit. As a result, the advantages according to the invention are thereby achieved.

Advantageous embodiments of the invention are the subject matter of the sub-claims.

Accordingly, the turbine blade according to the invention has bearing surfaces which are provided with elements that are plastically deformable by the action of heat.

Depending on the embodiment, the bearing surfaces allow correspondingly strengthened anchorage in the groove of the turbine shaft. When appropriately selected, the elements plastically deformable by the action of heat, because of their low rigidity, prevent extreme stress concentrations from being induced and protect the fiber composite structure of the blade root against increased temperatures, e.g. as a result of microfriction between the blade root and the groove in which the blade root is mounted.

The elements plastically deformable under the action of heat help to match the surfaces of the blade root and groove to one another, namely in that they also adapt to the existing geometries when heat is applied.

Reinforced or unreinforced thermoplastic can be used for the plastically deformable elements. They can be implemented using strips of material having a thickness ranging from 0.1 to 0.2 mm.

The heating arrangement used for applying heat to the blade root of a turbine blade according to the invention can be incorporated in the blade root itself. However, it can also be disposed outside the blade root. For example, it can be incorporated in a relevant turbine shaft or can be disposed both outside the blade root and outside the turbine shaft. It can be constituted by radiant heaters or similar. In addition, the heating arrangement can be designed such that its effect is based on the physical principle of microfriction or microwave.

A turbine shaft can still be made of steel.

Said heating arrangement can also be incorporated in the turbine shaft.

The turbine system can be a gas or steam turbine system.

In order to keep within limits the action of heat on the turbine blade according to the invention and on the turbine shaft according to the invention, in the case of a multistage turbine system at least the last, i.e. rearmost turbine stage, which is generally the coolest turbine stage, can be fitted with turbine blades according to the invention and a turbine shaft according to the invention.

In the turbine system according to the invention, the relevant heating arrangement can be provided remotely from a relevant blade root of a relevant turbine blade.

In particular, the heating arrangement can be disposed remotely from the turbine shaft.

Said heating arrangement can be designed such that its effect is based on the physical principle of microfriction between a relevant turbine blade and a relevant turbine shaft incorporating said turbine blade or according to the microwave principle.

Also in the case of an advantageous embodiment of the method for installing the relevant turbine blade on the relevant turbine shaft, the heating action takes effect in accordance with the physical principle of microfriction between the turbine blade and the turbine shaft or according to the microwave principle.

### BRIEF DESCRIPTION OF THE DRAWINGS

An exemplary embodiment of the invention will now be explained in greater detail with reference to a drawing in which the single FIGURE shows a partial cross-sectional view of a region in which a turbine blade 1 is installed on a turbine shaft 2. The turbine shaft 2 is shown in cross-section.

### DETAILED DESCRIPTION OF INVENTION

In this exemplary embodiment, the turbine blade 1 according to the invention is made of reinforced fiber composite material.

The turbine blade 1 is installed on the turbine shaft 2 by mounting the blade root 3 of the turbine blade 1 in the groove 4 of the turbine shaft 2.

According to the exemplary embodiment shown in the FIGURE, the blade root 3 has a fir tree shape with which the blade root 3 and therefore the turbine blade 1 is installed, i.e. inserted in a correspondingly complementary-shaped groove 4 of the turbine shaft 2. However, fits other than fir tree shape are likewise conceivable.

Irrespective of the shape of fit between the blade root 3 and the groove 4, the blade root 3 always has bearing surfaces 5 of some kind via which the blade root 3 is supported on corresponding wall sections 6 of the groove 4 in the installed state.

As shown in this FIGURE, said bearing surfaces 5 are part of the fir tree shape of the blade root 3.

To simplify the drawing, in the FIGURE the bearing surfaces 5 and the wall sections 6 are only marked once in each case.

To improve the fixing of the blade root 3 in the groove 4 of the turbine shaft 2, there is provided in the groove 4 according to this exemplary embodiment a compression spring 7 by which the bearing surfaces 5 of the blade root 3 are pressed in a backlash free manner against the wall sections 6 of the groove 4 which are disposed opposite the bearing surfaces 5.

To the arrangement shown in the FIGURE, comprising the blade root 3 of a turbine blade 1 and the groove 4 of a turbine shaft 2, wherein the blade root 3 is installed in the groove 4, there is assigned a heating arrangement 8 which is illustrated merely in a general manner in the FIGURE.

The heating arrangement 8 can be both placed at different locations in the arrangement and designed in accordance with different heat generation principles. As a result, the heat generated by the heating arrangement 8 acts on the blade root 3 of the turbine blade 1 and produces at the blade root 3, by corresponding plastic auto-adaptation of shape, a shape of fit finely matched to the shape of the groove 4.

As the FIGURE shows, the bearing surfaces 5 of the blade root 3 are provided with elements 9 plastically deformable by the action of heat, by means of which a further plastic adaptation of the shape of the blade root 3 of the turbine blade 1 to the shape of the groove 4 of the turbine shaft 2 is brought about due to the action of heat by said heating arrangement among other things.

To simplify the FIGURE, the elements 9, as previously the bearing surfaces 5 and the wall sections 6, are only marked once in each case in the drawing.

The turbine blade 1 and turbine shaft 2 shown in the FIGURE are part of a turbine system which is not shown in greater detail in the FIGURE.

1-16. (canceled)

17. A turbine blade of fiber-reinforced plastic material, comprising:
a blade root as a connecting element that is connectable to a turbine shaft, the turbine shaft having a groove for accommodating the blade root in the installed state of the turbine blade on the turbine shaft,
wherein the blade root has a shape of fit finely matched to the shape of the groove of the turbine shaft as a result of a heating effect produced by a heating arrangement and acting on the blade root during installation on the turbine shaft and as a result of auto-adaptation of the shape thereof to the shape of the groove of the turbine shaft.

18. The turbine blade as claimed in claim 17, wherein the blade root has bearing surfaces, such that when the blade is installed on the turbine shaft, the bearing surfaces support the blade root on corresponding wall sections of the groove of the turbine shaft, and that the bearing surfaces are provided with elements that are plastically deformable by the action of heat.

19. The turbine blade as claimed in claim 18, wherein the plastically deformable elements are reinforced or unreinforced thermoplasts.

20. The turbine blade as claimed in claim 19, wherein the plastically deformable elements are strips of material having a thickness ranging from 0.1 to 0.2 mm.

21. The turbine blade as claimed in claim 17, wherein the heating arrangement is incorporated in the blade root.

22. A turbine system, comprising:
a turbine shaft having at least one groove for a turbine blade with a blade root which, in the installed state of the turbine blade on the turbine shaft, is installed in the at least one groove of the turbine shaft, wherein said turbine blade is a turbine blade according to claim 17.

23. The turbine system as claimed in claim 22, wherein the turbine shaft is a steel turbine shaft.

24. The turbine system as claimed in claim 22, wherein the turbine system is a gas or steam turbine system.

25. The turbine system as claimed in claim 22, wherein the turbine shaft is disposed as a last turbine shaft of the turbine system.

26. The turbine system as claimed in claim 22, wherein the heating arrangement is provided remotely from the blade root for producing the heating effect on the blade root.

27. The turbine system as claimed in claim 26, wherein the heating arrangement is disposed remotely from the turbine shaft.

28. The turbine system as claimed in claim 26, wherein the heating arrangement is configured such that its effect is based on a physical principle of microfriction between the turbine blade the turbine shaft or on a microwave principle.

29. The turbine system as claimed in claim 22, wherein the heating arrangement is incorporated in the turbine shaft.

30. A method for installing a turbine blade as claimed in claim 17 on a turbine system shaft with a groove for accommodating the blade root of the turbine blade, comprising:
inserting the blade root into the groove the blade root for installing the turbine blade on the turbine shaft, and
matching the blade root finely to the shape of the groove of the turbine shaft during said installation, said matching comprising producing a heating effect via a heating arrangement, the heating effect being configured to produce an auto-adaptation in the shape of fit.

31. The method as claimed in claim 30, wherein the heating effect is produced according to the physical principle of microfriction between the turbine blade and the turbine shaft incorporating said turbine blade or according to a microwave principle.
